(19) United States
(12) Patent Application Publication
(10) Pub. No.: US 2011/0241351 A1
(43) Pub. Date: Oct. 6, 2011

(54) Power generating system employing a radial air cooled aircraft engine

(76) Inventor: Dale Euga, Raynham, MA (US)

(21) Appl. No.: 12/662,233

(22) Filed: Apr. 6, 2010

(51) Int. Cl. H02K 7/18; F02B 47/02; F01M 1/02; F02B 43/00

(52) U.S. Cl. 290/1 A; 123/25 R; 123/196 R; 123/1 A

(57) ABSTRACT

A system using a radial air cooled aircraft engine as the prime mover to drive a generator. The system's engine (prime mover) has been redesigned and modified to burn gaseous fuels such as propane, methane, natural gas, hydrogen, ethane, butane, digester gas, or landfill gas. The basic components of the system include a highly modified Pratt & Whitney radial aircraft engine, an optional torque converter, a flywheel, shaft couplers, cooling fans, and a generator with a main disconnect switch are enclosed in a standard shipping container.

The system is designed in an in-line arrangement of the basic components for the purpose of arranging the entire system inside a shipping container, or to be free standing inside a structure. The system is completely self contained, portable, capable of high altitude operations up to 15,000 feet above sea level, and designed to provide primary power in remote locations, primary power for small utility companies, decentralized electrical power for industrial, military, health care, or commercial needs.

The system has multiple configurations to generate electrical power from 500 kw up to 2 MW per unit and can be arranged in multiple units to produce up to 50 MW for a single powerhouse deployment.

Smaller systems designed to produce up to 500 kw would use a Pratt & Whitney R-1400 series radial engine with the same modifications as installed in the Pratt & Whitney R-2800 combined with a 500 kw generator. The standard unit is a 1 MW system using a Pratt & Whitney R-2800 series radial engine coupled with a 1 MW generator.

All units use a proprietary fuel delivery system (AFREDS, patent pending) that properly mixes the gaseous fuels with the proper fuel/air ratio to control engine performance efficiencies and to meet clean burn requirements.

The system generates electrical power using a radial air cooled aircraft engine that has been modified to run on gaseous fuels and drive an electric generator or alternator. The system is composed of three basic elements; prime mover, torque converter or transmission, and generator or alternator. In some applications, the prime mover may be coupled directly to the generator. The entire system's components are arranged inline on a single axis with the individual shafts connected with disconnect couplers to permit individual component servicing or replacement. The entire system is designed to be a portable system and therefore may be constructed inside a standard shipping container that has been modified to contain all of the system components and support equipment. Therefore, the fully assembled unit can be transported, installed, attached to a fuel source, and operated as a primary or auxiliary power source anywhere from sea level up to 18,000 feet above sea level without de-rating of the prime mover.

The engine modifications include the AFREDS (patent pending) fuel delivery apparatus that delivers gaseous fuels to the engine in a manner that causes the engine to run at a wide range of rpm, efficiently, and with full power to drive a generator. The containerized concept also allows the arrangement of multiple units to be stacked, aligned in parallel, configured cylindrically or other manner to multiply the output of the individual power generating unit and use a single switchgear element for all of the individual units as they may be added. Using this system “component concept” allows flexibility for the user to increase or decrease power output as the demand may dictate. Another major advantage of this multiple unit system is that it can also be disassembled and the units relocated and “plugged in” as the user's needs may require. The transmissions, generators and other components used in the system are shelf components readily available from a variety of manufacturers and as used in this system, they are hereby included by reference.

### DRAWING AND EXPLANATIONS

Page 1 is the drawing dated Jun. 31, 2009. This drawing is a horizontal section view of the unit and is the only drawing of the unit.

The components of the system are numbered on the drawing and identified as follows:
1. Engine starter
2. Compressor section of engine
3. Central cylinder banks of engine
4. Forward gearbox and nose casing of engine
5. Central drive shaft
6. Gas pipe from fuel source
7. Equipment shown inside of dotted line is the fuel delivery system
8. Induction cowling
9. Removable air filters
10. Indicates direction of combustion air flow
11. Shaft coupler
12. Engine lubrication oil recovery tank
13. Wall of shipping container
14. Torque converter
15. Torque converter mounting bracket
16. Generator
17. Generator mounting bracket
18. Ground (earth surface or prepared floor)

The standard container used for this system varies in length from 25 feet long up to a maximum of 40 feet long. Customer requirements will dictate the length of the container. All containers have full swing doors at the generator end and a pull down ramp at the engine end of the container. Cooling fans are fitted on a separate frame in front of the engine. Louvers, if needed, are fitted through the wall of the container for venting and engine cooling.

### APPLICATION MODELS

1. Commercial mining activities at elevations over 4,000 feet can take advantage of this portable system in multiple configurations because of the capabilities of the system to operate at altitude without any de-rating of the prime mover.

2. Any application of this portable system that used to replace a liquid fuel fired systems to eliminate problems associated with fuel contamination, fuel gelling, and elimination of site pollution associated with liquid fuel leaks and spills, especially diesel.

3. Any application to generate decentralized primary power for small communities or commercial activities in remote locations where a diesel driven units, or other types of power generation units are impractical.

4. Industrial processing that requires long periods of processing operations such as desalination, saw mills, water pumping, paper processing, etc. are commercial enterprises that require large quantities of reliable electrical power. This system is capable of multiple expansions at the same site to meet any growth and increasing electrical power needs that may be required by the user company.

5. Remote military establishments provide a special application of the technology. In fixed locations such as forts and air bases, the units can provide primary power and are unaffected by EMP. Further, the units are transportable and can be quickly deployed anywhere in the world by military air cargo.

6. Applications include providing independent electrical power in any area that has environmental issues or temporary power requirements wherein the unit is quiet, non-polluting and portable.

While the term “portable” has been used herein, it applies to this system as a completely containerized system wherein the shipping container is a basic component of the system and is therefore the entire unit is capable of being transported “as a container”. When the system is used inside a power plant, the system does not need the shipping container. Therefore the unit can be transported by almost any commercial means including air cargo. The further implication of the relative light weight of the system is that only a heavy duty fork lift is required to on-load and off-load the system onto a flatbed, container trailer rig, rail car, ship or aircraft.

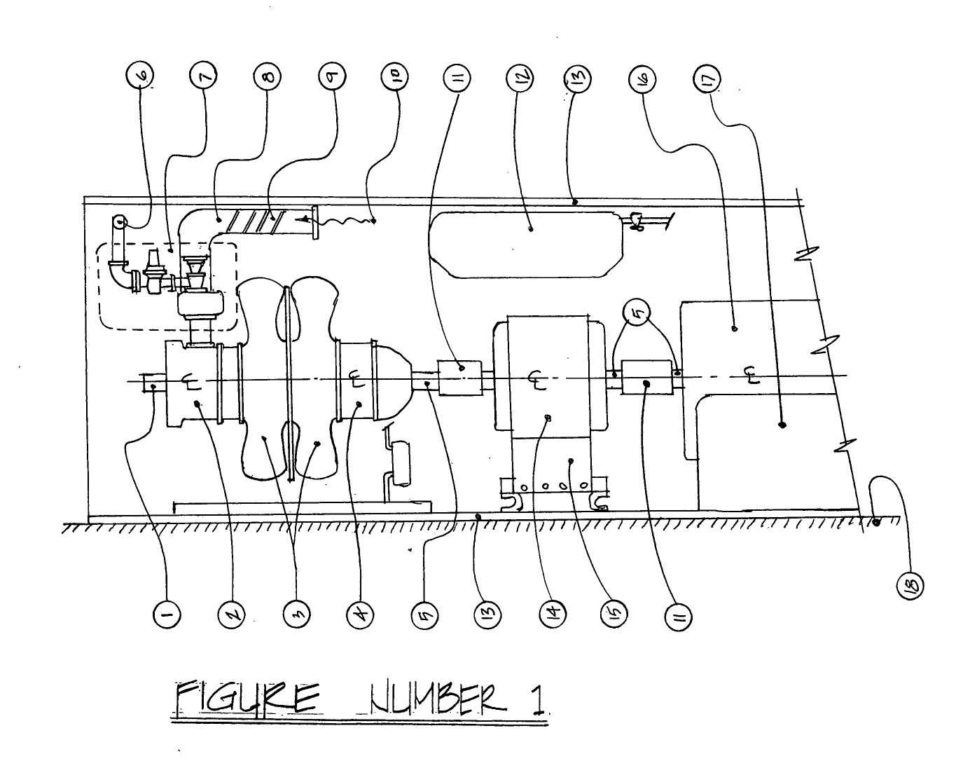

### FIG. 1

### Explanation

Page 1 is FIG. 1 dated Jun. 31, 2009. This FIGURE is a horizontal section view of the Invention and is the only drawing of the complete unit.

The components of the system are numbered on the drawing and identified as follows:
1. Engine starter
2. Compressor section of engine
3. Central cylinder banks of engine
4. Forward gearbox and nose casing of engine
5. Central drive shaft
6. Gas pipe from fuel source
7. Equipment shown inside of dotted line is the fuel delivery system
8. Induction cowling
9. Removable air filters
10. Indicates direction of combustion air flow
11. Shaft coupler
12. Engine lubrication oil recovery tank
13. Wall of shipping container
14. Torque converter
15. Torque converter mounting bracket
16. Generator
17. Generator mounting bracket
18. Ground (earth surface or prepared floor)

The standard container used for this system varies in length from 25 feet long up to a maximum of 40 feet long. Customer requirements will dictate the length of the container. All containers have full swing doors at the generator end and a pull down ramp at the engine end of the container. Cooling fans are fitted on a separate frame in front of the engine. Louvers, if needed, are fitted through the wall of the container for venting and engine cooling.

1: A SYSTEM composed of a prime mover and an electric generator for producing primary electrical power using an air cooled radial aircraft engine as the prime mover to drive an electric generator.

2: Whereas the prime mover as cited in claim 1 includes adaptation and modification of the radial aircraft engine fuel delivery system to accept a gaseous multi-fuel carburetion system with water injection capabilities.

3: Internal modifications to the cylinder walls of the radial aircraft engine cited in claim 1 to accept application of a lubricant coating to increase lubrication, extend engine life, and enhance clean burn combustion.

4: The use of a torque converter or a flywheel as needed as a component part of the system to regulate the power demand influxes between the prime mover and the generator.

5: The SYSTEM is designed to be compact such that it can be completely contained inside a standard shipping container and therefore, be portable.

6: Each component of the SYSTEM is designed such that it can be an interchangeable independent component.

7: The SYSTEM can be arranged in multiple units with each unit independently operating in parallel to produce a combined electrical power generation capability up to 20 MW.

8: The SYSTEM as cited in claim 1 is capable of generating electrical power at altitude up to 15,000 feet above sea level without de-rating the power output of the prime mover.

9: The prime mover cited in claim 1 is adaptable to replace other types of engines used to drive generators in existing power generation installations.

10: The prime mover as cited in claim 2 operates on propane, natural gas, methane, hydrogen, butane, ethane, digester gas, or landfill gas without any modification to the SYSTEM Additionally, the unit can also run on most standard liquid fuels.
